(19) United States
(12) Patent Application Publication
(10) Pub. No.: US 2023/0400433 A1
(43) Pub. Date: Dec. 14, 2023

(54) METHOD AND SYSTEM FOR REMOTELY MEASURING PROPERTIES OF A FLUID

(71) Applicant: INDIAN INSTITUTE OF TECHNOLOGY MADRAS (IIT MADRAS), Chennai, Tamil Nadu (IN)

(72) Inventors: Krishnan BALASUBRAMANIAN, Chennai, Tamil Nadu (IN); Nishanth R, Chennai, Tamil Nadu (IN)

(73) Assignee: INDIAN INSTITUTE OF TECHNOLOGY MADRAS (IIT MADRAS), Chennai, Tamil Nadu (IN)

(21) Appl. No.: 18/033,451

(22) PCT Filed: Oct. 26, 2021
(86) PCT No.: PCT/IN2021/051018

§ 371 Date: Apr. 24, 2023

(30) Foreign Application Priority Data
Nov. 5, 2020 (IN) 202041048337

(51) Int. Cl. G01N 29/024; G01N 29/032; G01N 29/22

(52) U.S. Cl. CPC G01N 29/024; G01N 29/032; G01N 29/221; G01N 2291/015; G01N 2291/011; G01N 2291/02818; G01N 2291/02836; G01N 2291/02881; G01N 2291/101

(57) ABSTRACT

Disclosed herein is a method and a system for remotely measuring the properties of a fluid. The system comprises a waveguide, a transducer, and a processing unit. One end of the waveguide is coupled to the transducer and the second end is immersed in a fluid. The transducer is aligned at a certain angle of excitation ranging between 0°-90° with respect to the waveguide such that it can transmit ultrasonic waves comprising at least two wave modes. A part of the at least two wave modes transmitted through the wave guide leaks into the surrounding fluid and the remaining part is reflected. The attenuation of the at least two wave modes is studied in various attenuation regimes ranging between 0-1200 kHz. The reflected at least two wave modes are transmitted to the processing unit for extracting various parameters. Based on the extracted parameters, different properties of the fluid are measured.

### FIELD OF THE INVENTION

The present invention relates to sensing devices and more particularly it relates to ultrasonic waveguide sensors for measuring properties of a fluid.

### BACKGROUND OF THE INVENTION

Generally Acoustic waveguide sensors have been used to measure physical properties of a fluid flowing or stored in a conduit or a vessel. However, requirement of precise level measurement and rheological measurement in industries like glass and metal melting plants, chemical, petrochemical, and fertilizer industries, nuclear power plants, etc. has motivated the people working in sensor designing field for usage of an ultrasonic waveguide sensor for the process of monitoring and measurements of properties of fluid.

Ultrasonic waves can be used for remote measurements in physically inaccessible areas and in hostile environments. Accordingly, ultrasonic waveguide sensors find utility in various applications because of the various advantages such as ability for remote measurements, multi-modal nature allowing for measurement of different parameters, small footprint, low cost, multi-point measurements on the same waveguide and most importantly robustness. In an ultrasonic waveguide sensing technique, a transducer is connected to the waveguide for transmission of ultrasonic waves from one end of the waveguide to the second end of the waveguide that is immersed in a fluid. The ultrasonic guided wave propagates in one of the three fundamental modes namely, longitudinal, torsional and flexural mode along the length of the waveguide. When a wave travels through the waveguide, a part of it leaks into the surrounding fluid and a part of it is reflected from the second end of the waveguide and is received by the transducer that transmits it for further analysis. The reflected wave mode contains information about the properties of the fluid the waveguide is immersed into and is therefore used to determine the properties of the fluid.

Earlier techniques have focused on the transmission of only one out of three wave modes and due to usage of a single wave mode measurement capability was limited to only one parameter of the fluid, i.e., at any given instant only one parameter such as either temperature, or viscosity, or density, or fluid level, or flow rate can be determined and therefore, the ability to perform multi-point measurements is restricted. Further, high temperature measurements are also not possible which seriously limits the use of the ultrasonic waveguide sensor in environments with high temperatures.

Thus, there exist a need to devise a method and a system for evaluating properties of the surrounding fluid with simultaneous generation and reception of at least two wave modes and the effect of operating frequency on the properties of the fluid.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In one embodiment of the present invention, a system for remotely measuring properties of a fluid is disclosed. The system comprises a waveguide and an ultrasonic transducer. The waveguide is of an elongated structure having a first end connected with the ultrasonic transducer and a second end immersed in the fluid. Further, the ultrasonic transducer is placed at the first end of the waveguide at such an angle that the waveguide transmits waves from its first end towards the second end in at least two wave modes at an operating frequency. The system further comprises a processing unit, operably coupled with the ultrasonic transducer, and configured to determine a time of flight and amplitude ratio of reflected waves received by the ultrasonic transducer in response to the waves transmitted from the first end of the waveguide. The processing unit of the system is further configured to measure the properties of the fluid, at the same operating frequency at which the waves are transmitted and reflected between the first end and the second end of the waveguide, based on the time of flight and the amplitude ratio determined.

In another embodiment of the present invention, the at least two wave modes comprises at least one of symmetric modes and an asymmetric mode, and wherein the symmetric modes comprises longitudinal (L(0,1)) mode and torsional (T(0,1)) mode, and wherein the asymmetric mode comprises a flexural (F(1,1)) mode.

In yet another embodiment of the present invention, the processing unit is configured to measure the properties of the fluid in the operating frequency range of 0-1200 kHz, wherein the operating frequency range is divided into a plurality of attenuation regimes comprising: an attenuation regime I with operating frequency between 0-400 kHz; an attenuation regime II with operating frequency between 400-800 kHz; and an attenuation regime III with operating frequency between 800-1200 kHz.

In still another embodiment of the present invention, the angle at which the ultrasonic transducer is placed with respect to the waveguide ranges between 0°-90°.

In another embodiment of the present invention, the properties of the fluid comprises at least one of viscosity, density, flow rate, level and temperature.

In one embodiment of the present invention, a method for remotely measuring properties of a fluid is disclosed. The method comprises configuring a waveguide and an ultrasonic transducer. The waveguide is of an elongated structure having a first end connected with the ultrasonic transducer and a second end immersed in the fluid. Further, the ultrasonic transducer is placed at the first end of the waveguide at such an angle that the waveguide transmits waves from its first end towards the second end in at least two wave modes at an operating frequency. The method further comprises determining a time of flight and amplitude ratio of reflected waves received by the ultrasonic transducer in response to the waves transmitted from the first end of the waveguide. The method further comprises measuring the properties of the fluid, at the same operating frequency at which the waves are transmitted and reflected between the first end and the second end of the waveguide, based on the time of flight and the amplitude ratio determined.

In another embodiment of the present invention, the at least two wave modes comprises at least one of symmetric modes and an asymmetric mode, and wherein the symmetric modes comprises longitudinal (L(0,1)) mode and torsional (T(0,1)) mode, and wherein the asymmetric mode comprises a flexural (F(1,1)) mode.

In yet another embodiment of the present invention, the method further comprises measuring the properties of the fluid in the operating frequency range of 0-1200 kHz, wherein the operating frequency range is divided into a plurality of attenuation regimes comprising: an attenuation regime I with operating frequency between 0-400 kHz; an attenuation regime II with operating frequency between 400-800 kHz; and an attenuation regime III with operating frequency between 800-1200 kHz.

In still another embodiment of the present invention, the angle at which the ultrasonic transducer is placed with respect to the waveguide ranges between 0°-90°.

In another embodiment of the present invention, the properties of the fluid comprises at least one of viscosity, density, flow rate, level and temperature.

The foregoing summary is illustrative only and is not intended to be in any way limiting. In addition to the illustrative aspects, embodiments, and features described above, further aspects, embodiments, and features will become apparent by reference to the drawings and the following detailed description.

### OBJECTS OF THE INVENTION

An object of the invention is to facilitate simultaneous generation and reception of at least two wave modes in order to perform multi-point measurements on the surrounding fluid.

Another object of the invention is to evaluate effect of operating frequency pertaining to various attenuation regimes on the properties of the at least two wave modes.

### BRIEF DESCRIPTION OF DRAWINGS

Further aspects and advantages of the present invention will be readily understood from the following detailed description with reference to the accompanying drawings, where like reference numerals refer to identical or functionally similar elements throughout the separate views. The figures together with the detailed description below, are incorporated in and form part of the specification, and serve to further illustrate the aspects and explain various principles and advantages, in accordance with the present invention wherein:

FIG. 1 shows a system 100 for remotely measuring the properties of a fluid in accordance with an embodiment of the present disclosure;

FIGS. 2A-2C illustrates the various configurations of a transducer with respect to the waveguide for the generation of at least two wave modes and the corresponding FEM simulations in accordance with an embodiment of the present disclosure;

FIG. 3 shows an A-scan signal from FEM for different angles of excitation (0°-90°) in accordance with an embodiment of the present disclosure;

FIGS. 4A and 4B illustrate simultaneous measurement of two properties of the fluid in accordance with an embodiment of the present disclosure;

FIG. 5 illustrates a frequency dependent attenuation plot during fluid load condition in accordance with an embodiment of the present disclosure;

FIGS. 6A-6C illustrate the variation of amplitude of a flexural, F(1,1) wave mode with frequency in accordance with an embodiment of the present disclosure;

FIG. 7A illustrates the frequency dependent variation of time of flight with liquid level for flexural, F(1,1) wave mode in accordance with an embodiment of the present disclosure;

FIG. 7B illustrates the frequency dependent variation of amplitude with liquid level for flexural, F(1,1) wave mode in accordance with an embodiment of the present disclosure; FIG. 7C illustrates the shift in the peak frequency of flexural F(1,1) wave mode for each attenuation regime with increase in the fluid level in accordance with an embodiment of the present disclosure; and

FIG. 8 depicts a method 800 for remotely measuring the properties of a fluid in accordance with an embodiment of the present disclosure.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION OF DRAWINGS

The present invention will be described herein with reference to the accompanying drawings. In the following description, well known functions or constructions are not described in detail since they would obscure the description with unnecessary detail.

The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Disclosed herein is a method and a system for remotely measuring the properties of a fluid. The properties of the fluid measured may include chemical and physical properties such as temperature, level of fluid and rheological properties. The system comprises a waveguide, a transducer, and a processing unit. One end of the waveguide is coupled to the transducer and the second end is immersed in a fluid. The transducer is coupled to the processing unit at one end and is aligned at a certain angle of excitation with respect to the waveguide at other end such that it can transmit ultrasonic waves comprising at least two wave modes. The at least two wave modes comprises a combination of either longitudinal (L(0,1)) wave mode and flexural (F(1,1)) wave mode, or a combination of torsional (T(0,1)) wave mode and flexural (F(1,1)) wave mode or all the three wave modes (longitudinal (L(0,1)), torsional (T(0,1)) and flexural (F(1,1))) may be transmitted simultaneously. A part of the at least two wave modes transmitted through the wave guide leaks (or loses energy) into the surrounding fluid and the remaining part is reflected. The leakage of a wave mode into the surrounding fluid is dependent on an operating frequency and therefore, the attenuation of the at least two wave modes have been studied in various attenuation regimes ranging between 0-1200 kHz. The reflected at least two wave modes are received by the transducer and further transmitted to the processing unit for extracting parameters such as the time of flight, amplitude, peak frequency, attenuation and like. Based on the extracted parameters, different properties of the fluid such as temperature, viscosity, liquid level, flow rate etc are measured. The major advantage offered by using at least two modes, is that the system can perform multi-point measurements effectively. In other words, the system can study two or more properties of the fluid simultaneously. In an embodiment, at a particular instant of time 5-6 properties of a fluid can be evaluated/measured simultaneously.

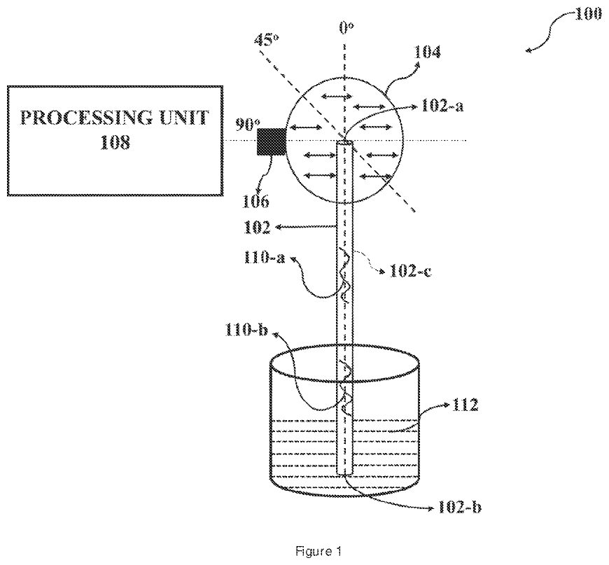

FIG. 1 shows a system 100 for remotely measuring the properties of a fluid in accordance with an embodiment of the present disclosure. It must be understood to a person skilled in art that the present invention may also be implemented in various environments, other than as shown in FIG. 1.

The system 100 comprises a waveguide 102, an ultrasonic transducer 104 that may be circular or flat and a processing unit 108. The waveguide 102 comprises a first end 102-a, an elongated structure 102-c and a second end 102-b. The first end 102-a of the waveguide 102 is connected to the transducer 104 and the second end 102-b of the waveguide 102 is immersed in a fluid 112. The fluid 112 may be a viscous or a non-viscous fluid. According to an embodiment, the waveguide 102 may be a metal waveguide having either a circular, flat or an oval cross section. According to another embodiment, the waveguide 102 may have different configurations such as bent, spiral or helical. The waveguide 102 may be of any type such as solid rod, wire, plate, sheet, hollow tube, pipe, shell, etc. A very thin film of an ultrasonic couplant (viscous silicone) is used between the waveguide 102 and the transducer 104 as well to establish proper contact and avoid the air gap. Using a mechanical fixture, the normal force between the waveguide 102 and the transducer 104 is optimized in order to maximize the amplitude of the F(1,1) mode. A connector 106 is affixed to the transducer 104 for aligning the transducer 104 at a given excitation angle with respect to the waveguide 102 such that the transducer 104 can transmit ultrasonic waves comprising at least two wave modes 110-a, 110-b through the waveguide 102 in a pulse-echo mode. The at least two wave modes 110-a, 110-b that propagate through the waveguide 102, partly leak to the fluid 112. Part of the at least two wave modes 110-a, 110-b is reflected from the second end 102-b of the waveguide 102. The reflected at least two wave modes 110-a, 110-b are received by the transducer 104 and transmitted to the processing unit 108. The processing unit 108 extracts various parameters such as time of flight, amplitude, peak frequency, attenuation and like. Based on the extracted parameters, different properties of the fluid 112 such as temperature, viscosity, liquid level, flow rate etc. are measured.

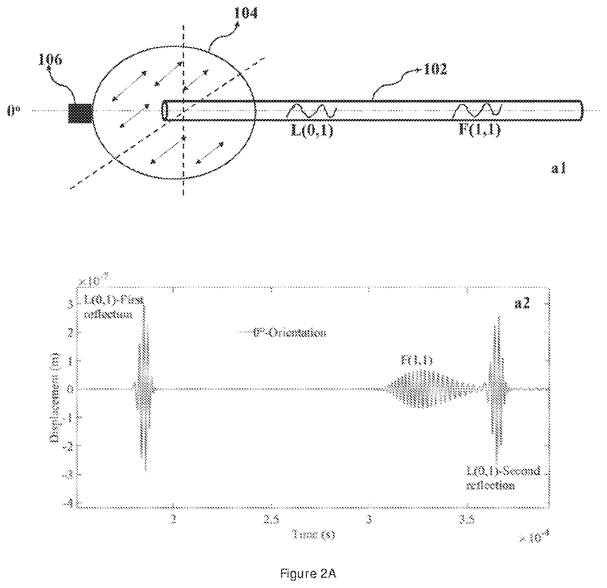

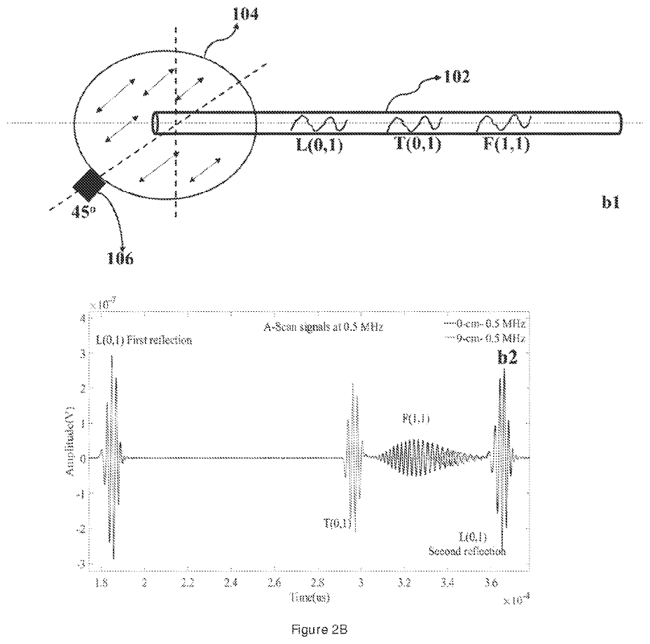

As mentioned in the above paragraph, wave are generated for measuring the properties of the fluid. The waves may be generated and received using one or more of the different mechanisms of guided wave generations such as Piezo-electricity (longitudinal and shear modes), Electro-Magnetic transduction (Magnetostriction, Lorentz Force, EMF, etc.), Thermal mechanisms (e.g. pulser laser), Microwave, Fiber Bragg Grating etc. Further, the generation of the wave modes 110-a, 110-b is dependent on the angle of alignment of the transducer 104 with respect to the waveguide 102. The waveguide can be made of different materials such as metals, ceramics, glass etc. The waveguides may have difference cross-sections including rectangular, circular, cylindrical, elliptical, triangular, diamond, hexagonal, etc. In cylindrical waveguide, symmetrical modes such as mode L(0,1) and T(0,1) and asymmetric wave mode F(1,1) can be generated. The at least two wave modes 110-a, 110-b comprises a combination of symmetric and asymmetric wave mode. In an embodiment, the at least two wave modes may be resulted from combination of either longitudinal (L(0,1)) wave mode and flexural (F(1,1)) wave mode, or a combination of torsional (T(0,1)) wave mode and flexural (F(1,1)) wave mode or all the three wave modes (longitudinal (L(0,1)), torsional (T(0,1)) and flexural (F(1,1))). These wave modes may be transmitted simultaneously. The wave modes—longitudinal, torsional, and flexural differ from each other on the basis of the speed at which they travel and the manner in which the molecules of the wave mode vibrates. While longitudinal wave mode is the fastest, flexural wave mode has the least speed. Because of being the slowest, flexural mode travels at a lower speed through the fluid 112 as compared to other wave modes. Due to this the flexural mode is highly sensitive to the fluid 112 and exhibits significant changes in the time of flight and amplitude in comparison to the other wave modes. Therefore, a combination of any wave mode—either longitudinal or torsional with the flexural mode helps in determining the properties of the fluid 112 more precisely. Further, multi-point measurements, that is, measurement of two parameters related to the fluid 112 simultaneously is also possible when at least two wave modes are used. The generation of at least two wave modes is illustrated in FIGS. 2A-2C.

FIG. 2A (a1) illustrates the alignment of the transducer 104 at an excitation angle of 0° with respect to the waveguide 102. This leads to the generation of a combination of L(0,1) and F(1,1) modes simultaneously as can be seen from the FEM simulation depicted in FIG. 2A (a2).

FIG. 2B (b1) illustrates the alignment of the transducer 104 at an excitation angle of 45° with respect to the waveguide 102. This leads to the generation of all the three wave modes—L(0,1), T(0,1) and F(1,1) simultaneously as can be seen from the FEM simulation depicted in FIG. 2B (b2).

FIG. 2C (c1) illustrates the alignment of the transducer 104 at an excitation angle of 90° with respect to the waveguide 102. This leads to the generation of a combination of T(0,1) and F(1,1) modes simultaneously as can be seen from the FEM simulation depicted in FIG. 2C (c2).

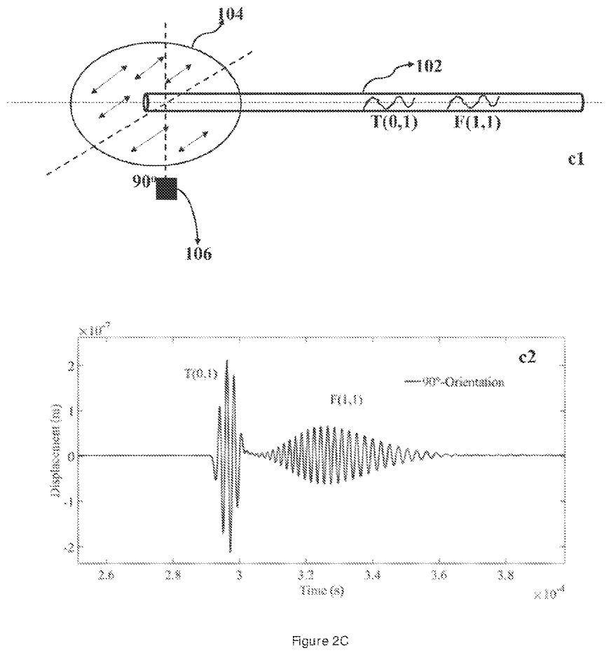

Further, apart from the excitation angles 0°, 45° and 90°, FEM simulations are also carried out for angles 10°, 20°, 30°, 60°, 70° and 80°, thereby covering an entire range of 0°-90° as illustrated in FIG. 3. It can be observed from FIG. 3, that for excitation angles ranging between 20°-80°, all the three wave modes can be generated. However, the amplitude of the generated wave modes varies with the angle of excitation.

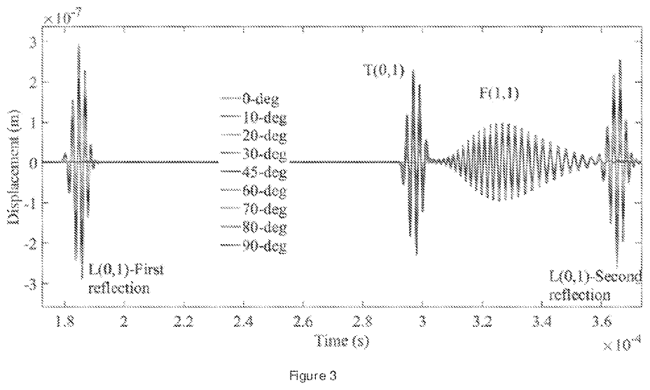

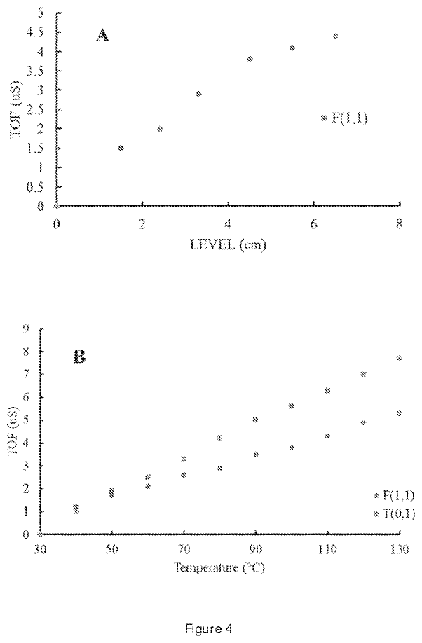

FIG. 4 illustrates the simultaneous measurement of level and temperature of the fluid 112. FIG. 4A shows that with increase in the fluid level, the time of flight (ToF) of the F(1,1) mode increases. On the other hand, from FIG. 4B, it can be clearly seen that with increase in the temperature the ToF of both T(0,1) and F(1,1) modes increases. Therefore, the variation of time of flight clearly helps in measuring the change in the level and temperature of the fluid simultaneously.

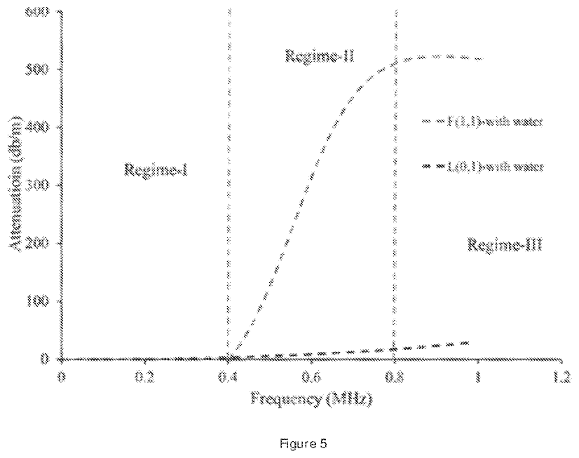

Further, since the flexural mode is highly sensitive to the fluid 112 and exhibits significant changes in the time of flight and amplitude in comparison to the other wave modes because of its low speed in comparison to the fluid, the dispersion effects of the F(1,1) mode in comparison to the other wave modes are examined and illustrated in FIG. 5. FIG. 5 shows three attenuation regimes, each corresponding to a frequency range. Attenuation regime I ranges from 0-400 kHz, while attenuation regime II ranges from 400-800 kHz and attenuation regimes III ranges from 800-1200 kHz. Particularly, FIG. 5 provides comparison of F(1,1) mode and L(0,1) mode in the three attenuation regimes. For the L(0,1) mode, it is clearly seen from FIG. 5 that no significant changes occur in attenuation in any of the three regimes during fluid 112 loading. This points out to the fact that the L(0,1) has a very low sensitivity to any changes in the fluid 112 level in all the three attenuation regimes. Therefore, even at a high operating frequency of 1000 kHz, simply using a L(0,1) mode would not present with accurate measurements for the fluid 112 level. On the other hand, the F(1,1) mode shows distinct behaviour in each of the three regimes. In attenuation regimes I, that is below 400 kHz, the attenuation of the F(1,1) mode is negligible due to the absence or minimum wave leakage into the fluid 112. However, as the frequency is increased from 400 kHz up to 800 kHz, that is in attenuation regime II, the attenuation increases rapidly. The attenuation of the F(1,1) mode increases further when the frequency is further increased from 800 kHz.

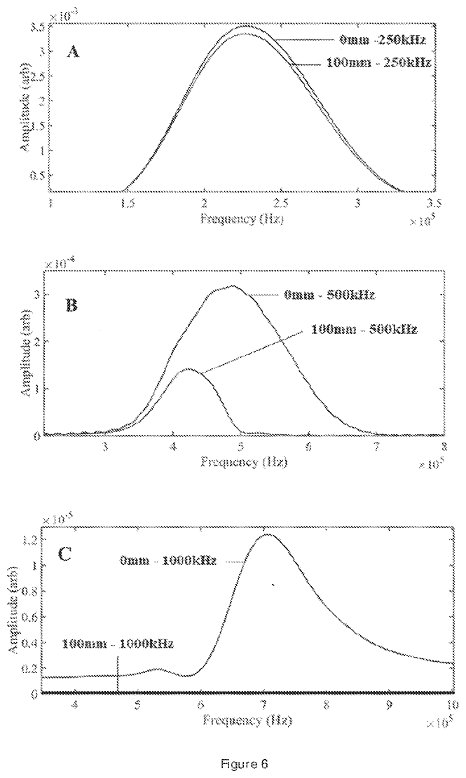

To examine how well the F(1,1) mode responds to an increase in the fluid 112 level, frequency dependent studies are carried out and same is presented in FIGS. 6A-6C. The fluid 112 considered for the study is water and the measurements were taken at 0 mm and 100 mm of water level. Attenuation regime I was considered during the measurement presented in FIG. 6A and the central frequency was chosen as 250 kHz. FIG. 6A shows a negligible change in the amplitude of the F(1,1) mode when the water level changes from 0 mm to 100 mm, thereby corroborating the fact that the attenuation of F(1,1) mode is negligible in attenuation regime I due to minimal/no wave leakage. Further, attenuation regime II is presented in FIG. 6B where the central frequency is selected as 500 kHz. FIG. 6B depicts a significant drop in the amplitude of the F(1,1) wave mode when the water level changes from 0 mm to 100 mm, thereby corroborating the fact that the attenuation of F(1,1) mode is significantly higher in attenuation regime II. Furthermore, attenuation regime III is presented in FIG. 6C where the central frequency is selected as 1000 kHz. FIG. 6C depicts that the amplitude of the F(1,1) wave mode reduces to almost zero as the water level changes from 0 mm to 100 mm, thereby corroborating the fact that the attenuation of F(1,1) mode is even higher in attenuation regime III.

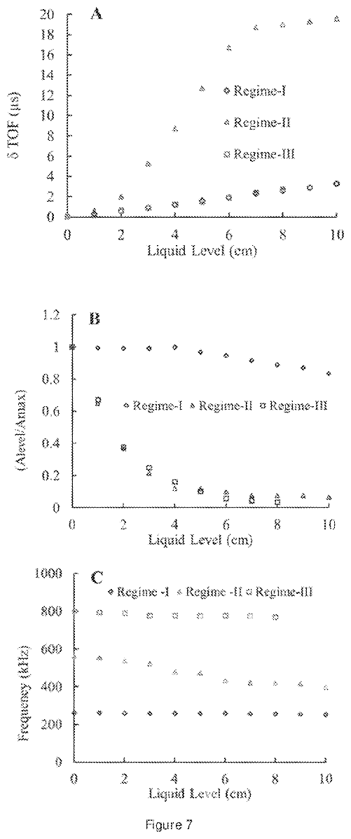

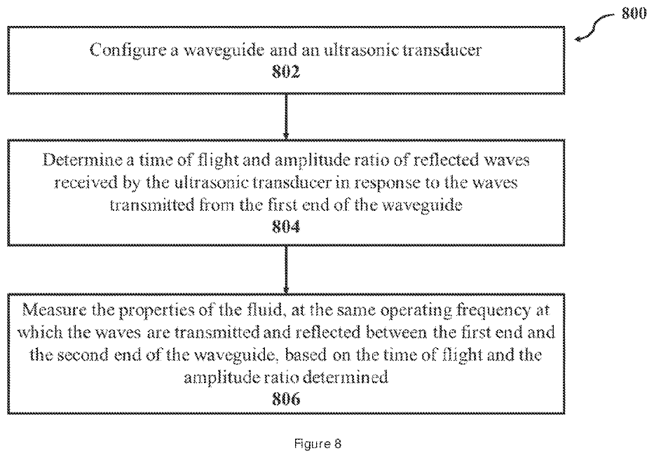

Further studies have been carried out showing variation of fluid 112 level with ToF, amplitude and peak frequency of the F(1,1) mode in different attenuation regimes as shown in FIGS. 7A-7C respectively. As shown in FIG. 7A, the variation of time of flight with fluid 112 level is small for attenuation regimes I and III. On the other hand, the time of flight varies considerably with the increase in the fluid 112 level in attenuation regime II. However, in FIG. 7B, the variation of amplitude with fluid 112 level is small for attenuation regimes I but varies considerably with the increase in the fluid 112 level for attenuation regimes II and III. Further, from FIG. 7C, for a peak frequency of 250 kHz, that is in attenuation regime I, the shift in the peak frequency is negligible with increase in the fluid 112 level due to minimal/no leakage of the F(1,1) wave mode in the fluid 112. However, at peak frequencies of 500 kHz and 1000 kHz, that is in attenuation regimes II and III, the shift in the peak frequency is quite significant due to the attenuation dispersion effects of F(1,1) at this operating frequency regimes. Further, in attenuation regime III, attenuation and the wave leakage of F(1,1) to the fluid medium is higher when compared to attenuation regimes I & II and merges with the T(0,1) since both the F(1,1) and T(0,1) velocity matches at this operating frequency. The operating frequency depends on the thickness and material properties of the waveguide. Based on the operating frequencies, attenuation regimes are evaluated and corresponding results are summarised in table 1 as presented below:

TABLE 1
Response of three-wave mode to inviscid fluid
112 loading at different attenuation regimes

| Attenuation | Frequency | | |
|---|---|---|---|
| Regime | shift | TOF shift | Amplitude drop |
| I (250 kHz) | F(1, 1) | F(1, 1) | L(0, 1), F(1, 1) |
| II (500 kHz) | F(1, 1) | F(1, 1) | L(0, 1), F(1, 1) |
| III (1000 kHz) | F(1, 1) | F(1, 1) | L(0, 1), F(1, 1) |

From the studies presented in FIGS. 4-7, it can be concluded that owing to better sensitivity/dispersive nature, the F(1,1) mode is appropriate for accurate level sensing and effective for wide-range level measurement (i.e. more than 100 mm (Attenuation Regime-I) and less than 100 mm (Attenuation Regime-II and Attenuation Regime-III)). Whereas, the L (0,1) and T(0,1) modes exhibit limited sensitivity/dispersive nature and could be employed for very long-range level sensing trials. However, the choice of the wave mode and its optimum operating frequency would rely on the application.

FIG. 8 depict a method 800 for remotely measuring properties of a fluid in accordance with an embodiment of the present disclosure.

As illustrated in FIG. 8, the method 800 includes one or more blocks illustrating a method for remotely measuring properties of a fluid. The method 800 may be described in the general context of computer executable instructions. Generally, computer executable instructions can include routines, programs, objects, components, data structures, procedures, modules, and functions, which perform specific functions or implement specific abstract data types.

The order in which the method 800 is described is not intended to be construed as a limitation, and any number of the described method blocks can be combined in any order to implement the method. Additionally, individual blocks may be deleted from the methods without departing from the spirit and scope of the subject matter described herein.

At block 802, the method 800 may include configuring a waveguide 102 and an ultrasonic transducer 104. The waveguide 102 is of an elongated structure having a first end 102-a connected with the ultrasonic transducer 104 and a second end 102-b immersed in the fluid 112. Further, the ultrasonic transducer 104 is placed at the first end 102-a of the waveguide 102 at such an angle that the waveguide 102 transmits waves from its first end 102-a towards the second end 102-b in at least two wave modes 110a, 110b at an operating frequency.

At block 804, the method 800 may include determining a time of flight and amplitude ratio of reflected waves received by the ultrasonic transducer 104 in response to the waves transmitted from the first end 102-a of the waveguide 102.

At block 806, the method 800 may include measuring the properties of the fluid 112, at the same operating frequency at which the waves are transmitted and reflected between the first end 102-a and the second end 102-b of the waveguide 102, based on the time of flight and the amplitude ratio determined.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A system for remotely measuring properties of a fluid, the system comprising:
a waveguide and an ultrasonic transducer, wherein the waveguide is an elongated structure having a first end connected with the ultrasonic transducer and a second end immersed in the fluid;
wherein the ultrasonic transducer is placed at the first end of the waveguide at such an angle that the waveguide transmits waves from its first end towards the second end in at least two wave modes at an operating frequency;
and wherein the system further comprises a processing unit, operably coupled with the ultrasonic transducer, the processing unit is configured to:
determine a time of flight and amplitude ratio of reflected waves received by the ultrasonic transducer in response to the waves transmitted from the first end of the waveguide; and
measure the properties of the fluid, at the same operating frequency at which the waves are transmitted and reflected between the first end and the second end of the waveguide, based on the time of flight and the amplitude ratio determined.

2. The system as claimed in claim 1, wherein the at least two wave modes comprises at least one of symmetric modes and an asymmetric mode, and wherein the symmetric modes comprises longitudinal (L(0,1)) mode and torsional (T(0,1)) mode, and wherein the asymmetric mode comprises a flexural (F(1,1)) mode.

3. The system as claimed in claim 1, wherein the processing unit is configured to measure the properties of the fluid in the operating frequency range of 0-1200 kHz, wherein the operating frequency range is divided into a plurality of attenuation regimes comprising:
an attenuation regime I with operating frequency between 0-400 kHz;
an attenuation regime II with operating frequency between 400-800 kHz; and
an attenuation regime III with operating frequency between 800-1200 kHz.

4. The system as claimed in claim 1, wherein the angle at which the ultrasonic transducer is placed with respect to the waveguide ranges between 0°-90°.

5. The system as claimed in claim 1, wherein the properties of the fluid comprises at least one of viscosity, density, flow rate, level and temperature.

6. A method for remotely measuring properties of a fluid, the method comprising:
configuring a waveguide and an ultrasonic transducer, wherein the waveguide is an elongated structure having a first end connected with the ultrasonic transducer and a second end immersed in the fluid;
wherein the ultrasonic transducer is placed at the first end of the waveguide at such an angle that the waveguide transmits waves from its first end towards the second end in at least two wave modes at an operating frequency;
determining, by a processing unit, a time of flight and amplitude ratio of reflected waves received by the ultrasonic transducer in response to the waves transmitted from the first end of the waveguide; and
measuring, by the processing unit, the properties of the fluid, at the same operating frequency at which the waves are transmitted and reflected between the first end and the second end of the waveguide, based on the time of flight and the amplitude ratio determined.

7. The method as claimed in claim 6, wherein the at least two wave modes comprises at least one of symmetric modes and an asymmetric mode, and wherein the symmetric modes comprises longitudinal (L(0,1)) mode and torsional (T(0,1)) mode, and wherein the asymmetric mode comprises a flexural (F(1,1)) mode.

8. The method as claimed in claim 6, wherein the properties of the fluid are measured in the operating frequency range of 0-1200 kHz, wherein the operating frequency range is divided into a plurality of attenuation regimes comprising:
an attenuation regime I with operating frequency between 0-400 kHz;
an attenuation regime II with operating frequency between 400-800 kHz; and
an attenuation regime III with operating frequency between 800-1200 kHz.

9. The method as claimed in claim 6, wherein the angle at which the ultrasonic transducer is placed with respect to the waveguide ranges between 0°-90°.

10. The method as claimed in claim 6, wherein the properties of the fluid comprises at least one of viscosity, density, flow rate, level and temperature.
